(19) United States
(12) Patent Application Publication
(10) Pub. No.: US 2012/0171087 A1
(43) Pub. Date: Jul. 5, 2012

(54) Methods for Facilitating Fluid Flow Through Nanoporous Membranes

(75) Inventors: Thomas R. Gaborski, Rochester, NY (US); James L. McGrath, Fairport, NY (US); Richard D. Richmond, Canandaigua, NY (US); Christopher C. Striemer, Rochester, NY (US)

(73) Assignee: SIMPORE, INC., West Henrietta, NY (US)

(21) Appl. No.: 13/496,012

(22) PCT Filed: Oct. 1, 2010
(86) PCT No.: PCT/US10/51115

§ 371 Date: Mar. 14, 2012

Related U.S. Application Data
(60) Provisional application No. 61/248,171, filed on Oct. 2, 2009.

(51) Int. Cl. B01L 3/00; B01D 69/02; F15D 1/00; B82Y 40/00; B82Y 30/00; B82Y 99/00

(52) U.S. Cl. 422/533; 210/500.21; 137/1; 977/780; 977/902; 977/840

(57) ABSTRACT

The present invention is drawn to methods for facilitating fluid flow through the nanopores of membranes, i.e., through sub-micron pores. The present invention is also directed to one or more apparatus for such fluid flow, and for nanoporous membranes modified to facilitate such fluid flow.

### CROSS-REFERENCE TO RELATED APPLICATIONS

This application claims priority to U.S. Provisional Application Ser. No. 61/248,171, filed Oct. 2, 2009. The disclosure of this provisional application is hereby incorporated by reference in its entirety in the present application.

### FIELD OF THE INVENTION

The present invention is drawn to methods for facilitating fluid flow through the nanopores of membranes, i.e., through sub-micron pores. The present invention is also directed to one or more apparatus for such fluid flow, and for nanoporous membranes modified to facilitate such fluid flow.

### BACKGROUND OF THE INVENTION

Membranes that are permeable to a fluid such as water because they contain nanopores (i.e., pores in the sub-micron diameter range), such as porous nanocrystalline Si (“pnc-Si”), as defined in, e.g., U.S. patent application Ser. No. 11/414,991, the content of which is herein incorporated by reference in its entirety, polycarbonate track-etched, irradiated silicon nitride, anodized alumina, polymeric, and carbon nanotube-based membranes, have an inherent difficulty in passing water or other liquids from one side (the “entry” side, “proximal” side, or membrane “front” side) through the nanopores to the other side (the “exit” side, “distal” side, or membrane “backside”). Specifically, it requires an enormous amount of force for the water to navigate the nanopore exit (i.e., the portion of the nanopore that is adjacent to the exit side of the nanoporous membrane) and actually exit the nanopore. This process is conveniently analogized to blowing bubbles out of the end of a nanometer-sized straw, where, according to the Young-Laplace equation, it would require ˜100 atmospheres of differential pressure across the membrane to blow a bubble through a ˜30 nm nanopore “straw” (FIG. 1). This situation is unique to nanopores since, for larger, micron-width pores, the same theoretical considerations show that the required pressure is about 100-fold less, i.e., less than an atmosphere.

Although there are some situations in which a sufficiently high pressure on the order of a hundred atmospheres can be generated to force water or another fluid though a membrane with nanopores, in general it is either difficult or frequently impossible to obtain such high pressures, or to apply such pressures without membrane damage/rupture. Therefore, there is a need for developing methods for facilitating the flow of water or other fluids though such nanoporous membranes, and particularly uniquely performing membranes such as, e.g., pnc-Si membranes.

### SUMMARY OF THE INVENTION

The following aspects of the present invention represent a non-limiting list of various aspects of the present invention.

In aspect 1, the present invention is drawn to a method for increasing the flow of a fluid through the nanoporous openings of a nanoporous membrane, comprising flowing a fluid through the nanoporous openings of a nanoporous membrane from the fluid-entry side to the fluid-exit side of the permeable membrane, where at least the fluid-exit side of the nanoporous membrane has been modified to increase the affinity of the fluid for the surface to promote wetting through capillarity, thereby initiating and increasing fluid flow through the openings of the nanoporous membrane.

In aspect 2, the present invention is drawn to the method of aspect 1, where at least the fluid-exit side of the nanoporous membrane is modified by application of a substance selected from the group consisting of a hydrophilic substance and a hygroscopic substance.

In aspect 3, the present invention is drawn to the method of aspect 2, where the substance is polyvinylpyrrolidone (PVP), allyl alcohol, or a combination thereof.

In aspect 4, the present invention is drawn to the method of aspect 3, where only the fluid-exit side of the nanoporous membrane is modified.

In aspect 5, the present invention is drawn to the method of aspect 1, where the nanoporous openings of the nanoporous membrane are less than about 500 nm in average diameter.

In aspect 6, the present invention is drawn to the method of aspect 5, where the nanoporous openings of the nanoporous membrane are less than about 100 nm in average diameter.

In aspect 7, the present invention is drawn to the method of aspect 5, where the nanoporous openings of the nanoporous membrane are less than about 50 nm in average diameter.

In aspect 8, the present invention is drawn to the method of aspect 5, where the nanoporous openings of the nanoporous membrane are about 30 nm in average diameter.

In aspect 9, the present invention is drawn to the method of aspect 1, where the nanoporous membrane is a porous nanocrystalline silicon (pnc-Si) membrane.

In aspect 10, the present invention is drawn to the method of aspect 1, where the fluid-exit side of the nanoporous membrane is arranged so as to be in contact with a wetting fluid.

In aspect 11, the present invention is drawn to the method of aspect 10, where the wetting fluid is an aqueous wetting fluid.

In aspect 12, the present invention is drawn to the method of aspect 11, where the aqueous wetting fluid is water.

In aspect 13, the present invention is drawn to the method of aspect 10, where the wetting fluid is protected from displacement by centrifugal force.

In aspect 14, the present invention is drawn to a nanoporous membrane having a fluid-entry side, a fluid-exit side, and nanoporous openings in the nanoporous membrane providing fluidic contact between the fluid-entry side of the nanoporous membrane and the fluid exit-side of the nanoporous membrane, where at least the fluid-exit side of the nanoporous membrane has been modified to enable wetting of the fluid contacting the fluid-exit side of the nanoporous membrane.

In aspect 15, the present invention is drawn to a nanoporous membrane having a fluid-entry side, a fluid-exit side, and nanoporous openings in the nanoporous membrane providing fluidic contact between the fluid-entry side of the nanoporous membrane and the fluid-exit side of the nanoporous membrane, where the nanoporous openings have been modified to enable wetting of the fluid exiting from the nanoporous openings to the fluid-exit side of the nanoporous membrane.

In aspect 16, the present invention is drawn to the nanoporous membrane of aspect 15, where the nanoporous openings have been modified in the region of the openings adjacent to the fluid-exit side of the nanoporous membrane.

In aspect 17, the present invention is drawn to the nanoporous membrane of aspect 16, where the nanoporous openings have been modified by the application of a hydrophilic substance or a hygroscopic substance.

In aspect 18, the present invention is drawn to the nanoporous membrane of aspect 17, where the nanoporous openings have been modified by the application of PVP.

In aspect 19, the present invention is drawn to the nanoporous membrane of aspect 16, where the nanoporous openings have been modified so as to have an increasingly wide diameter in the region of the openings adjacent to the fluid-exit side of the nanoporous membrane.

In aspect 20, the present invention is drawn to a centrifugal-separation device comprising a separation vial (10 of FIG. 5) for containing a solution to be separated in the interior of the separation vial, where the separation vial terminates in a nanoporous membrane (20 of FIG. 5) which has a fluid-entry side (22 of FIG. 5) in fluidic contact with the interior of the separation vial, nanoporous openings through which the solution to be separated flows, and a fluid-exit side (24 of FIG. 5) to which the solution to be separated flows from the nanoporous openings; wherein the fluid-exit side of the nanoporous membrane has been modified to enable wetting of the fluid-exit side of the nanoporous membrane, thereby initiating and increasing fluid flow through the openings of the nanoporous membrane.

In aspect 21, the present invention is drawn to the centrifugal-separation device of aspect 20, further comprising a bottom bucket for providing a wetting fluid in contact with the fluid-exit side of the nanoporous membrane.

In aspect 22, the present invention is drawn to the centrifugal-separation device of aspect 21, where the bottom bucket is designed so as to protect the wetting fluid from displacement by centrifugal force.

In aspect 23, the present invention is drawn to the centrifugal-separation device of aspect 21, where the bottom bucket is designed so as to have an open bottom with exit ports that allow air bubbles to escape.

In aspect 24, the present invention is drawn to the centrifugal-separation device of aspect 21, where the bottom bucket is designed so as to have access ports the allow use of a pipette to add or remove fluid to the bucket.

### BRIEF DESCRIPTION OF THE DRAWINGS

The invention is better understood by reading the following detailed description of the present invention in conjunction with the accompanying drawings, wherein:

FIG. 1. Pressure required to push a bubble out of a nanopores can be more than 100 atmospheres and is defined by the Young-Laplace equation.

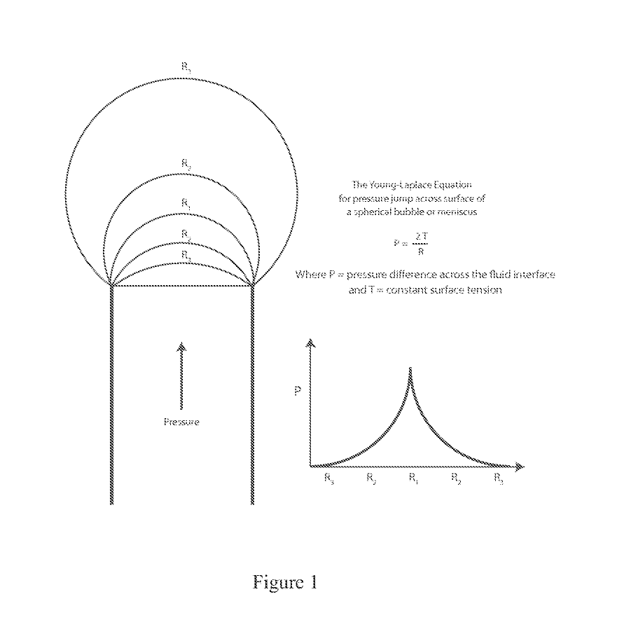

FIG. 2. Pnc-Si membranes can be impermeable in wet-dry configurations. Pnc-Si membranes were tested for water permeability in both a centrifuge and in a constant pressure cell. Membranes that are exposed to water on only side are not permeable to water at experimental pressures (0.1-1 atm), while membranes wetted on both sides have significant water permeability. Membranes coated with hygroscopic PVP were permeable to water when exposed to water on only one side. These samples had had a delayed start in fluid flow leading to a lower time-averaged permeability.

FIG. 3. UV/Ozone and oxygen plasma treatment increases membrane hydrophilicity. In the effort to develop wet/dry permeability we treated pnc-Si membranes with UV and Ozone with a Novascan PSD-UVT system or oxygen plasma in a Yield Engineering Systems 1224P vapor deposition chamber. In the Novasan device, membranes were exposed to three minutes of oxygen at 50° C. followed by three minutes of UV treatment at 50° C. The membranes were undisturbed in the chamber for 15 more minutes to allow the ozone react with the samples. In the Yield Engineering System device, membranes were exposed to oxygen plasma for 15 minutes at 150° C. Both figures show 3 microliter droplets of DI water. The fluid is so flat on the treated sample that it is hard to discern, except for the disturbance of the water layer caused by a small piece of debris.

FIG. 4. (A) Circular pnc-Si chip formatted for plastic centrifuge tube inserts. Inset is a TEM micrograph of pore morphology. The two internal slits are areas of freestanding active pnc-Si membrane. (B) Assembled centrifuge tube insert. (C) Schematic of water permeability test. The insert is filled with water and placed in a larger collection tube pre-filled with water. The system is spun in a centrifuge, and the volume of water that passes through the membrane is measured. Permeability measurements are taken before the system reaches equilibrium (version 1).

FIG. 5. Prototype of a centrifugal device that maintains water contact on both sides of a nonporous membrane (version 2). Exit ports on bottom bucket enable pipette access to add and remove water from the bottom bucket.

### DETAILED DESCRIPTION OF THE INVENTION

In the present invention, a variety of approaches are presented for facilitating nanoporous membrane permeability for low-pressure situations, e.g., pressures of well below 100 atmospheres. Although these methods are particularly suitable for “low” atmospheric pressures in the sub-100 atmosphere range, these methods, apparatus, modified membranes, etc., are explicitly not limited to such “low” pressures. Although these methods may be applied to any of the nanoporous membranes discussed herein or otherwise known to one of ordinary skill in the art of the use of such membranes, in one preferred aspect of the present invention these methods are specifically directed to the “pnc-Si” membranes described and prepared as provided in U.S. patent application Ser. No. 11/414,991, where the invention of the present application is particularly advantageous because of the unique properties of pnc-Si membranes.

Thus for example the present invention includes methods for facilitating liquid permeability through a nanoporous membrane by creating liquid contact with both the entry and particularly exit surfaces of the membrane, and methods for facilitating liquid permeability by applying at least one hygroscopic or wetting material to the exit side of the membrane. With regard to such materials, the present invention is drawn to a variety of hygroscopic and hydrophilic materials, including, but not limited to polyvinylpyrrolidone (PVP), hydroxyethyl (meth)acrylate polymer, (meth)acrylamide polymer, N,N-dimethylacrylamide polymer, N-vinylpyrrolidone polymer, polyethylene glycol, polyethylene oxide, polyvinyl alcohol, polyacrylic acid, polyethyleneoxide bisacetic acid, gelatin, casein, polyvinyl alcohol, methyl cellulose, carboxymethyl cellulose (CMC), sodium salt of CMC, acrylic acid, sodium polyacrylate, poly(4-vinyl-N-butylpyridinium bromide), homo allyl alcohol butanol, 2-butanol (crotyl alcohol), 2-methyl-2-propene-1-ol (methallyl alcohol), allyl alcohol, atomic layer deposited films and plasma or ozone treated carbon deposited films. Other contemplated materials include additional known hygroscopic and hydrophilic materials; also included are materials that are similarly hygroscopic but are (mis)termed “hydroscopic.” Thus the present invention contemplates the use of hydrophilic, hygroscopic, and “hydroscopic” materials or any combination thereof.

It should be understood that the methods for facilitating liquid permeability of the present invention ultimately result in increased flow of liquid through the nanoporous membranes described herein, for example through pnc-Si nanoporous membranes. In some cases there is no observable liquid flow through nanoporous membranes unless the methods of the present invention are utilized—see, e.g., Example 1. Thus in some instances “increased flow of liquid” refers to flow versus no flow. In other cases, “increased flow of liquid” refers to an increase relative to a lower (but non-zero) flow rate.

Facilitation of liquid flow may be determined by any method capable of measuring flow or displacement of liquid across the nanoporous membranes of the invention, e.g., measurements of fluid decrease in the fluid-entry side, fluid increase in the fluid-exit side, measurements of bulk flow across the membrane, etc. Although not bound by any specific theory as to how the various aspects of the present invention result in increased fluid flow, one possible non-limiting mechanism may be that the coatings used in the present invention facilitate initiation of fluid flow on the fluid-exit side of the nanoporous membrane.

The materials of the present invention may be applied to a variety of nanoporous membranes, including polycarbonate track-etched, irradiated silicon nitride, anodized alumina, polymeric, and carbon nanotube-based membranes, and, in a preferred aspect, the nanoporous membranes provided in U.S. patent application Ser. No. 11/414,991, particularly the “pnc-Si” membranes provided in this reference. Further with regard to the nanoporous membranes contemplated herein, nanopores of a variety of sizes are contemplated, i.e., pores of a variety of widths of less than 1 μm. Thus the widths of the nanopores contemplated include, but are not limited to, pores of less than about 500 nm, 100 nm, 50 nm, 30 nm, 20 nm, 10 nm, 5 nm, etc., where the smaller the average pore width in the nanoporous membrane, the greater the advantageous effects of the methods of modification of the present invention are likely to be.

In addition to the above methods, the present invention also includes implementations of one or more apparatus for use in these methods, nanoporous membranes coated so as to perform according to these methods, methods of coating such nanoporous membranes, etc.

Although the present invention is particularly drawn to permeability for aqueous liquids, solvents other than water are explicitly contemplated herein, including such non-limiting examples as ethanol, methanol, hexane, pentane, heptane, and cyclohexane.

### Example 1

### Development of Methods for Increasing Nanoporous Membrane Permeability

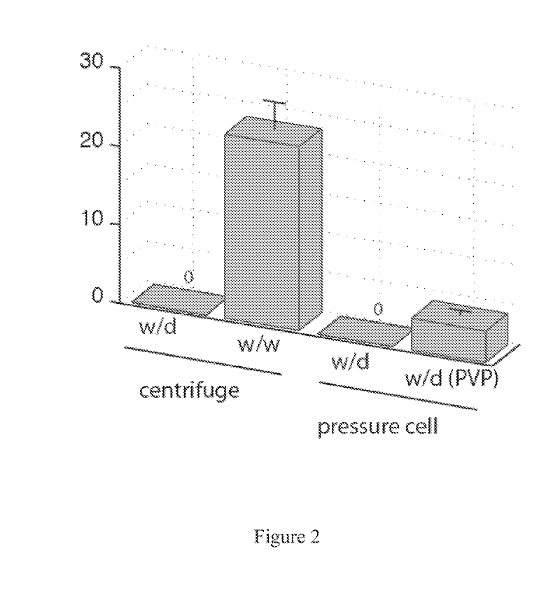

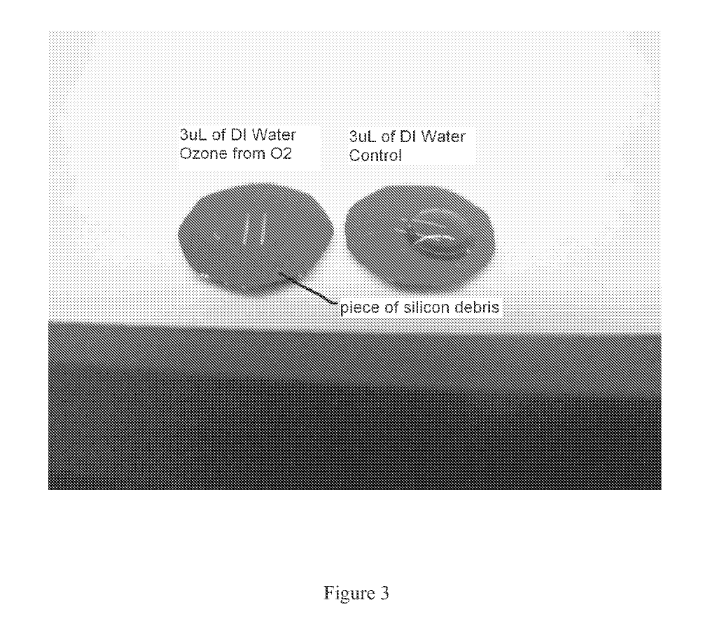

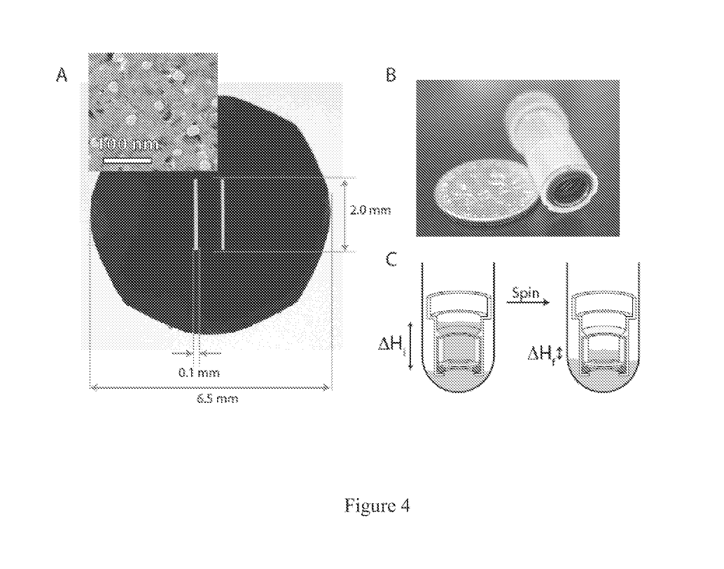

In our initial attempts to measure the hydraulic permeability of our pnc-Si nanoporous membranes (see, e.g., U.S. patent application Ser. No. 11/414,991, and the methods and materials described therein), we discovered that membranes are impermeable to water when one side of the membrane is dry (FIG. 2). We adopted several strategies to overcome water impermeability of the wet/dry configuration, including the use of high pressures (>1 atmosphere), ozone treatment of membranes to decrease contact angles from ˜70 degrees to less than 15 degrees (See FIG. 3), and lowering surface tension 2-3 fold by adding surfactants (0.2 wt % SDS or 0.2 wt % Triton X-100) or using ethanol instead of water. We also switched from centrifuge-generated pressure to a simple pressure cell because we suspected centrifugal forces were quickly removing fluid droplets from the membrane backside and stopping flow (note that this observation led us to develop methods and apparatus for preventing/reducing the removal of such fluid droplets, e.g., the bottom bucket centrifuge configuration provided in Example 2 below). High water permeability was only observed when we immersed the membrane in water throughout the experiment (see FIG. 4) or added a hygroscopic polymer, polyvinylpyrrolidone (PVP), to the membrane backside.

Although not bound by any particular theory, the most reasonable explanation for impermeability data obtained above is that in a front side wet/backside dry situation, water cannot wick from the front side of the nanoporous membrane through the nanopores to wet the backside of the membrane. As already discussed, we suspect that the meniscus in a filled nanopore cannot navigate the pore exit, so that forcing water through the membrane is akin to blowing water bubbles out of the end of a ˜30 nm straw, a process that would require ˜100 atmospheres of differential pressure across the membrane. Such pressures exceed the strength of pnc-Si membranes by two orders of magnitude, and could not be reduced more than a few fold by the use of surfactants or ethanol; therefore such pressures are not feasible for such pnc-Si membranes. Even for other nanoporous membranes, such pressures are sufficiently difficult to obtain that other alternatives to overcoming this problem are preferable.

In wet/wet experiments, five hundred microliters of deionized water was added to the interior of a centrifugal-separation device comprising a separation vial ending in a nanoporous membrane, and also to the centrifuge tube into which the centrifugal-separation vial was ultimately placed. Before placing the separation vial into the centrifuge tube, a 30 microliter droplet of water from the centrifuge tube was removed and applied to the backside of the nanoporous membrane to prevent an air bubble from forming beneath the membrane during immersion. The top of the centrifuge tube was sealed to prevent evaporation, and the centrifuge tube was placed in a centrifuge and spun for 30-60 minutes at 100 RCF. After the experiment was finished, the separation vial was removed from a centrifuge tube. Any remaining water on the backside of the separation vial was removed and added back into the centrifuge tube. The centrifuge tube and separation vial final weights were subtracted from initial values to determine the volume of water in each. In most experiments, 100-200 microliters of deionized water passed through the nanoporous membrane over the course of 30-60 minutes of centrifugation, i.e., between 20-40% of the water originally added to the interior of the separation vial.

In order to generate fluid flow without the requirement of immersion of the backside of the nanoporous membrane, we treated the membrane backside with an exemplary hygroscopic agent, polyvinylpyrrolidone (PVP). Three microliters of 1 mg/mL PVP in methanol (w/v) was pipetted onto the backside of a membrane. The membrane was allowed to dry for a minimum of two hours under ambient conditions. The membrane was assembled into the pressure cell with 500 microliters of deionized water in the feed tube. The pressure was held constant at 3 PSI for 30 minutes, and the water on the backside was collected and measured on a balance. Initial flow rates were low, likely due to a delay in the wetting process. This could explain the low calculated permeability values for PVP treated membranes compared to wet/wet format. After accounting for the initial wetting stage, the water flux was comparable to the wet/wet experiments described above.

### Example 2

### Optimization of Designs for Centrifuged Nanoporous Membranes

Version 1 (FIG. 4c). As already discussed, initial centrifugal-separation device use required a wet-wet interface in centrifuge operation. Driving pressure of water across the membrane is defined by the difference in water height from the inside to outside of the device. During standard operation, the initial height of water in the outer tube matches the height of the membrane so as to enable fluid interconnect across the membrane. Driving pressure will reduce as the difference in heights becomes less and eventually reaches equilibrium. This eliminates the possibility of driving all of the fluid through the membrane and drying the retained species on the membrane surface. To maximize the flow of water through the separation vial, the cross sectional area of the separation vial should be much smaller than the outer tube. For example, if the cross sectional area of the outer tube minus the displacement of the separation vial is 10 times larger than the area of the device, 90% of the fluid in the device would flow into the outer tube before reaching equilibrium.

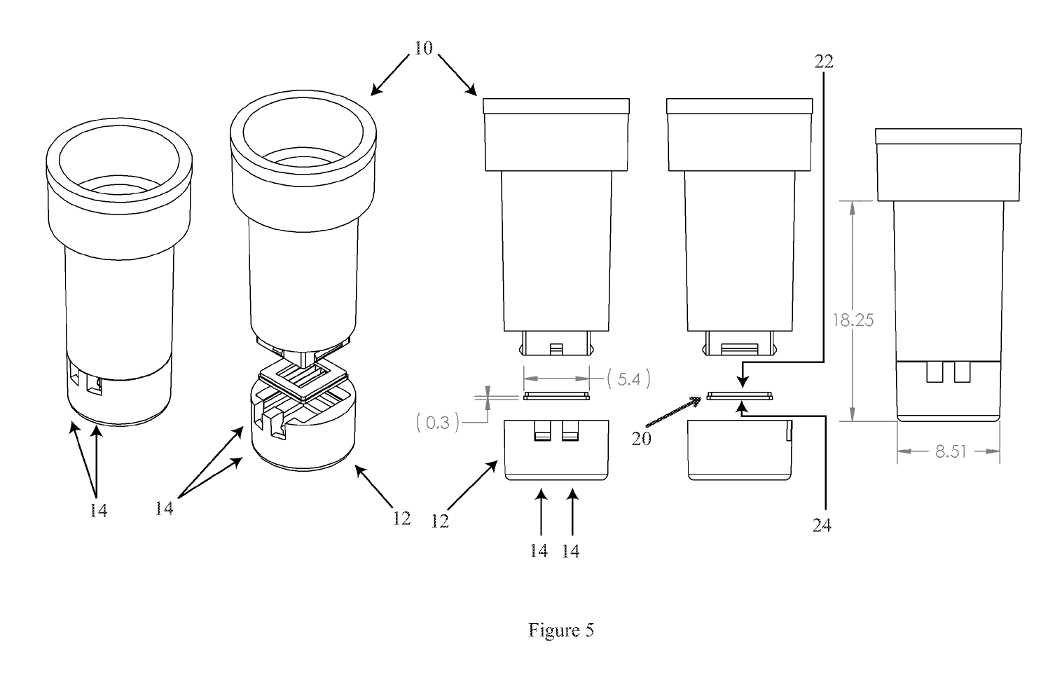

Version 2 (FIG. 5). In many cases, the separation vial 10 shape and geometry is defined by standard centrifuge tube formats. To maintain fluid interconnect across the membrane 20 without being limited by reaching equilibrium with the outer tube, a bottom bucket 12 can be attached to the separation vial 10, with escape ports 14 higher than the height of the nanoporous membrane that allow fluid to overflow into the centrifuge tube below. If this bucket 12 is pre-filled with fluid before placing the centrifugal-separation device in the centrifuge, fluid interconnect across the membrane is made and will be maintained during operation. The flow will continue until the water height in the device reaches the height of the escape ports 14. This can be designed to ensure that the device cannot be spun dry or to concentrate the retained species to a predetermined volume. Additionally, this bottom bucket 12 enables surface modification of the membrane with hygroscopic or hydrophilic materials such as PVP or allyl alcohol to initiate and maintain water flow across the membrane. When using the conventional design without an attached bucket, the increased gravitational forces in the centrifuge pull droplets initiated by the hygroscopic material to the bottom of the outer tube. This process re-dries the membrane surface and interrupts flow. If the bucket bottom 12 is fabricated with minimal void space beneath the membrane, new droplet formation is protected from being driven the bottom of the outer tube. These droplets eventually fill the bucket 12 and provide a continuous fluid interconnect across the membrane 20 eliminating the need to pre-fill the bucket before operation.

Those skilled in the art will appreciate that many modifications to the exemplary embodiment of the present invention are possible without departing from the spirit and scope of the present invention. In addition, it is possible to use some of the features of the present invention without the corresponding use of the other features. Accordingly, the foregoing description of the exemplary embodiment is provided for the purpose of illustrating the principles of the present invention and not in imitation thereof since the scope of the present invention is defined solely by the appended claims.

What is claimed is:

1. A method for increasing the flow of a fluid through the nanoporous openings of a nanoporous membrane, comprising flowing a fluid through the nanoporous openings of a nanoporous membrane from the fluid-entry side to the fluid-exit side of the permeable membrane, where at least the fluid-exit side of the nanoporous membrane has been modified to reduce the surface tension of the fluid contacting the fluid-exit side of the nanoporous membrane, thereby increasing fluid flow through the openings of the nanoporous membrane.

2. The method of claim 1, where at least the fluid-exit side of the nanoporous membrane is modified by application of a substance selected from the group consisting of a hydrophilic substance and a hygroscopic substance.

3. The method of claim 2, where the substance is polyvinylpyrrolidone (PVP), allyl alcohol, or a combination thereof.

4. The method of claim 3, where only the fluid-exit side of the nanoporous membrane is modified.

5. The method of claim 1, where the nanoporous openings of the nanoporous membrane are less than about 500 nm in average diameter.

6. The method of claim 5, where the nanoporous openings of the nanoporous membrane are less than about 100 nm in average diameter.

7. The method of claim 5, where the nanoporous openings of the nanoporous membrane are less than about 50 nm in average diameter.

8. The method of claim 5, where the nanoporous openings of the nanoporous membrane are about 30 nm in average diameter.

9. The method of claim 1, where the nanoporous membrane is a porous nanocrystalline silicon (pnc-Si) membrane.

10. The method of claim 1, where the fluid-exit side of the nanoporous membrane is arranged so as to be in contact with a wetting fluid.

11. The method of claim 10, where the wetting fluid is an aqueous wetting fluid.

12. The method of claim 11, where the aqueous wetting fluid is water.

13. The method of claim 10, where the wetting fluid is protected from displacement by centrifugal force.

14. A nanoporous membrane having a fluid-entry side, a fluid-exit side, and nanoporous openings in the nanoporous membrane providing fluidic contact between the fluid-entry side of the nanoporous membrane and the fluid exit-side of the nanoporous membrane, where at least the fluid-exit side of the nanoporous membrane has been modified to enable wetting of the fluid contacting the fluid-exit side of the nanoporous membrane.

15. A nanoporous membrane having a fluid-entry side, a fluid-exit side, and nanoporous openings in the nanoporous membrane providing fluidic contact between the fluid-entry side of the nanoporous membrane and the fluid-exit side of the nanoporous membrane, where the nanoporous openings have been modified to enable wetting of the fluid exiting from the nanoporous openings to the fluid-exit side of the nanoporous membrane.

16. The nanoporous membrane of claim 15, where the nanoporous openings have been modified in the region of the openings adjacent to the fluid-exit side of the nanoporous membrane.

17. The nanoporous membrane of claim 16, where the nanoporous openings have been modified by the application of a hydrophilic substance or a hygroscopic substance.

18. The nanoporous membrane of claim 17, where the nanoporous openings have been modified by the application of PVP or allyl alcohol.

19. The nanoporous membrane of claim 16, where the nanoporous openings have been modified so as to have an increasingly wide diameter in the region of the openings adjacent to the fluid-exit side of the nanoporous membrane.

20. A centrifugal-separation device comprising a separation vial for containing a solution to be separated in the interior of the separation vial, where the separation vial terminates in a nanoporous membrane which has a fluid-entry side in fluidic contact with the interior of the separation vial, nanoporous openings through which the solution to be separated flows, and a fluid-exit side to which the solution to be separated flows from the nanoporous openings; wherein the fluid-exit side of the nanoporous membrane has been modified to enable wetting of the fluid-exit side of the nanoporous membrane, thereby initiating and increasing fluid flow through the openings of the nanoporous membrane.

21. The centrifugal-separation device of claim 20, further comprising a bottom bucket for providing a wetting fluid in contact with the fluid-exit side of the nanoporous membrane.

22. The centrifugal-separation device of claim 21, where the bottom bucket is designed so as to protect the wetting fluid from displacement by centrifugal force.

23. The centrifugal-separation device of claim 21, where the bottom bucket is designed so as to have an open bottom with exit ports that allow air bubbles to escape.

24. The centrifugal-separation device of claim 21, where the bottom bucket is designed so as to have access ports the allow use of a pipette to add or remove fluid to the bucket.
